(19) United States
(12) Patent Application Publication
(10) Pub. No.: US 2008/0074488 A1
(43) Pub. Date: Mar. 27, 2008

(54) METHOD AND APPARATUS FOR CONTEXT SENSITIVE CONTROL OF ASSOCIATED DEVICES

(75) Inventor: Maria B. Thompson, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/530,924

(22) Filed: Sep. 12, 2006

(51) Int. Cl. H04N 7/14

(52) U.S. Cl. 348/14.08

(57) ABSTRACT

A method (100) or system (600) of controlling audible alerts includes detecting (102) a communication event among participant devices (204 and 206), detecting (104) a non-participant device (208, 210 or 212) within a predetermined range of a participant device, and sending (106) a wireless control signal by at least one among the participant devices to the non-participant device to control audible alert functions. The wireless control signal can be sent (108) after a start of the communication event and can be sent (110) for example using Bluetooth signaling, signaling using an IEEE 802.11 standard, or any other signaling. The method can mute (112) audible alerts on the non-participant device in response to receipt of the wireless control signal. Detecting the communication event can include detection of an instant messaging session, a telephone conference, a video conference, a audio-visual conference, internet or online or web conferencing, or a calendared event.

### FIELD

This invention relates generally to control of associated devices, and more particularly to a method and system of controlling associated devices based on contextual information.

### BACKGROUND

Communication devices and tools used by today's office workers have increased productivity, but in some instances have increased interruptions and ambiguity in certain settings. Many devices and tools used in an office setting operate independently of each other and therefore fail to provide or enhance person-to-person or multi-person communication in a manner where communication is unambiguous, non-intrusive, and effective. Knowledge of modes and settings among devices used in the office environment whether such devices participate in a particular communication session is typically not shared. Such settings are certainly not shared with devices not participating in a communication session. Nor is the context in which the different devices are used shared among non-participating devices.

Whether a worker is currently involved in communication events such as a telephone conference, an instant messaging session, an email application session, a video conference, or a network meeting or Netmeeting would fail to be known by devices that are non-participants in the communication event. Furthermore, the non-participant devices would fail to have knowledge of the user preferences of the operation of the non-participant devices when the user is currently involved in a communication event with participant devices.

### SUMMARY

Embodiments in accordance with the present invention can provide a method and system for sharing contextual information among communication devices to enable control of devices that might not necessarily be in a predetermined communication session.

In a first embodiment of the present invention, a method of controlling audible alerts can include the steps of detecting a communication event among participant devices, detecting a non-participant device within a predetermined range of a participant device, and sending a wireless control signal by at least one among the participant devices to the non-participant device to control audible alert functions of the non-participant device. The method can further mute audible alerts on the non-participant device in response to a receipt of the wireless control signal. The wireless control signal can be sent after a start of the communication event and can be sent for example using Bluetooth signaling, signaling using an IEEE 802.11 standard, or any other two-way communication signaling. The step of detecting the communication event can include the detection of an instant messaging session, or the detection of an internet conference, a web conference, an online conference, a telephone conference, a video conference or an audio-visual conference, or the detection of a calendared event on an electronic calendar or a plurality of calendars. Note, the sending of the wireless control signal by the at least one participant device can cause any remaining participant devices to send a wireless control signal to any non-participant devices detected by the remaining participant devices.

In a second embodiment of the present invention, a system of controlling audible alerts during communication events can include a communication device in a communication network and a processor coupled to the communication device. The communication device can be a desktop computer, a computer terminal, a laptop computer, a cellular phone, a smart phone, a personal digital assistant, or a two-way wireless communication device for example. The processor can be programmed to detect a communication event among participant devices including the communication device, detect a non-participant device within a predetermined range of a participant device, and send a wireless control signal by at least one among the participant devices to the non-participant device to control audible alert functions of the non-participant device. Note, this should be understood to include sending wireless control signals by at least one among the participant devices to any one of the non-participant devices to control audible alert functions of any one of the non-participant devices. The system can mute audible alerts on the non-participant device in response to a receipt of the wireless control signal by the non-participant device. Note, peripherals used by the participant devices can be considered a non-participant device in the context of muting audible alerts as contemplated herein. For example, a keyboard that creates or activates sounds as keys are typed on a participant device can be considered a non-participant device that can be muted in response to a receipt of the wireless control signal by a non-participant device. The processor can be programmed to send the wireless control signal after a start of the communication event. The wireless control signal can be sent using any number of communication signaling schemes including Bluetooth signaling, signaling using an IEEE 802.11 standard, or any other two-way communication signaling for example.

The processor can be further programmed to detect the communication event by detecting an instant messaging session, a telephone conference, a video conference, an audio-visual conference, or a calendared event on an electronic calendar. The processor can be further programmed to send the wireless control signal by causing any remaining participant devices among the participant devices to send a wireless control signal to any non-participant devices detected by the remaining participant devices.

In a third embodiment of the present invention, a portable communication device serving as a communication device in a communication network can include a transceiver and a processor coupled to the transceiver. The processor can be programmed to detect a communication event among participant devices including the portable communication device, detect a non-participant device within a predetermined range of the portable communication device serving as a participant device, and send a wireless control signal by at least one among the participant devices to the non-participant device to control audible alert functions of the non-participant device. The processor can be further programmed to send the wireless control signal after a start of the communication event. The processor can also be programmed to detect the communication event by detecting an instant messaging session, a telephone conference, a video conference, an audio-visual conference, or a calendared event on an electronic calendar.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing as well as a machine readable storage for causing a machine to perform the various processes and methods disclosed herein.

### BRIEF DESCRIPTION OF THE DRAWINGS

FIG. 1 is a flow chart illustrating a method of controlling audible alerts in accordance with an embodiment of the present invention.

FIG. 2 is a system for controlling audible alerts in accordance with an embodiment of the present invention.

FIG. 3 is another system including a portable communication device for controlling audible alerts in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways in various devices such as in personal digital assistants, cellular phones, laptop computers, desktop computers and the like. Generally speaking, pursuant to these various embodiments, a method, system or device can include a means for determining the context or modes of the various devices utilized by a user which can further include determining personal preferences and a manner of sharing such information. Such a system can increase productivity by reducing or suppressing intrusive or interruptive inputs into a communication session.

Background knowledge and sensed information utilized in a context aware system in an interaction mode can help determine what a user uses the most or prefers over time in different environments. Such a system can possibly determine what information is important to remember over time by logging and recording the person's active communication mode(s) or applications and noting interactions over time. A user engaging in email or Instant Messaging (IM) or Netmeeting may not want to be interrupted by an audible alert from a cellular phone and might prefer such alert as an incoming IM message or email instead. The user can decide whether such alert should be shared with some or all participants rather than intrusively providing an audible alert that can be heard by possibly all participants in a conference call for example.

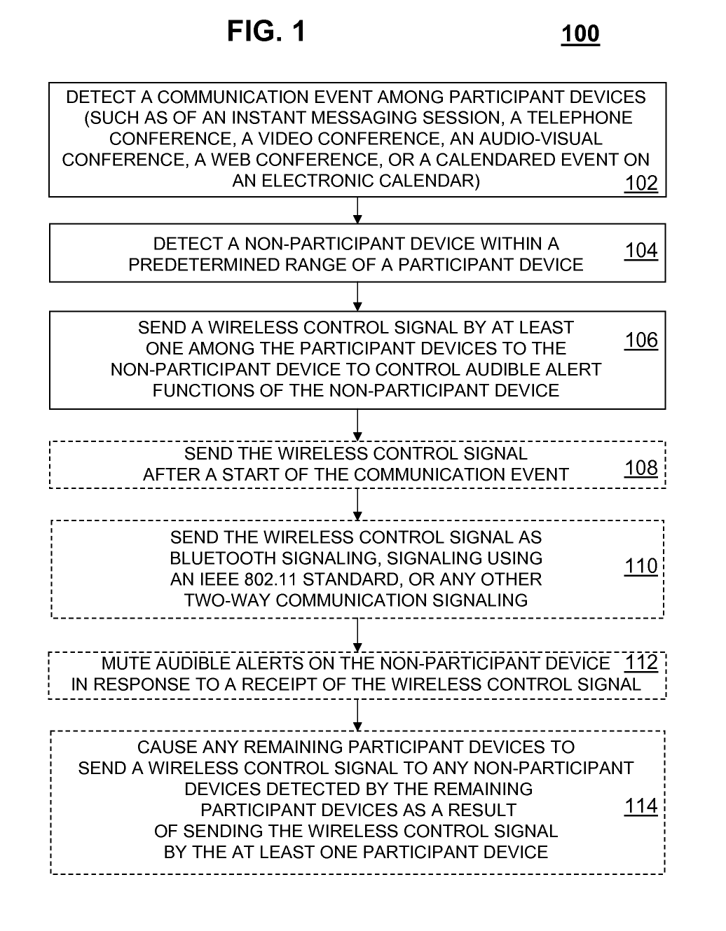

Referring to FIG. 1, a method 100 of controlling audible alerts can include the step 102 of detecting a communication event among participant devices, detecting a non-participant device within a predetermined range of a participant device at step 104, and sending a wireless control signal by at least one among the participant devices to the non-participant device to control audible alert functions of the non-participant device at step 106. The predetermined range can vary based on design, but can typically be similar to the range utilized among Bluetooth devices. The wireless control signal can be sent after a start of the communication event at step 108 and can be sent for example using Bluetooth signaling, signaling using an IEEE 802.11 standard, or any other two-way communication signaling at step 110. The method 100 can further mute audible alerts on the non-participant device in response to a receipt of the wireless control signal at step 112. The step 102 of detecting the communication event can include the detection of an instant messaging session, or the detection of an internet conference, a web conference, an online conference, a telephone conference, a video conference or an audio-visual conference, or the detection of a calendared event on an electronic calendar. Note, the sending of the wireless control signal by the at least one participant device can cause any remaining participant devices to send a wireless control signal to any non-participant devices detected by the remaining participant devices as illustrated at step 114. The determination of how a device is considered a “participating” versus a “non-participating” device can be based on an initial list of participants on a conference call or other list found in a user calendar or elsewhere and such “participating” or “non-participating” designation can change over a course of a conference call based on a user intervention or selection or based on a user profile setting for each type of conference call.

As an example, when a user is in the midst of an IM conversation on a computer, the method 100 can either suppress incoming calls to a non-participant device such as a cellular phone or can suppress the ringing on the cellular phone. The determination can be done by checking user preferences for quiet conversation associated to a calendar entry indicative of a current meeting or conference call before any phone gives audible ring. Thus, only silent modes of alerts and communication on all of a user's devices can be engaged or activated when the user is in a conference, meeting, or other setting calling for silence. Note, all laptop or desktop audibles can be similarly set for silent mode so that no loud sounds indicating new emails coming in, or Windows O/S booting, or extraneous or mimicked typing sounds will avoid disturbing the user or other participants in a communication session. Optionally, the silent mode at one participant can cause or trigger a control signal for all participants in a communication session to transmit control signals to their respective non-participant devices within their respective vicinities. The silent mode can also optionally control or block any audio or sounds associated with pop-up screens or advertisements or WAV files that a user may be opening while typing on a computer or surfing a website when multi-tasking during a conference call. The silent mode can also be useful in a Master-Slave muting scenario when a teacher or presenter desires to mute all students or participant devices in order to avoid disruptive interruptions. Thus, a facilitator or presenter may want to mute all devices in a formal business presentation or a manager may want to mute all employee devices when engaged in a staff meeting. Thus the “master” can be programmed to override all participant slave device mute settings.

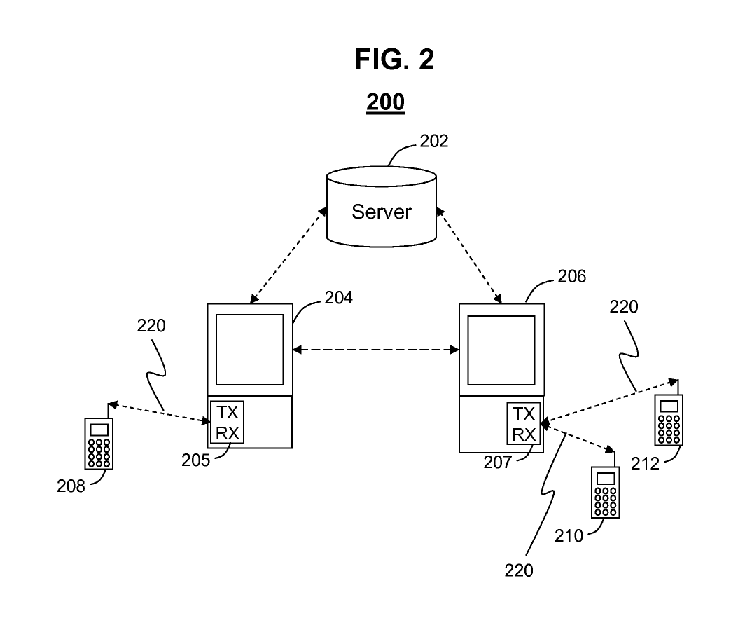

Referring to FIG. 2, a communication system 200 is shown that can control audible alerts during communication events and can include at least one client or communication device (204 or 206) in a communication network and a processor coupled to the communication device. The communication device 204 or 206 can be a desktop computer, a computer terminal, a laptop computer, a cellular phone, a smart phone, a personal digital assistant, or a two-way wireless communication device for example. The communication device can be part of a network and coupled to a server 202 for example. The server 202 can be an email server, a IM server or any other type of communication server that can link the participating communication devices 204 and 206. The processor can be programmed to detect a communication event among participant devices (204 and 206) including the communication device, detect a non-participant device (208, 210 or 212) within a predetermined range of a participant device, and send a wireless control signal 220 by at least one among the participant devices to the non-participant device to control audible alert functions of the non-participant device. The system can mute audible alerts on the non-participant device in response to a receipt of the wireless control signal by the non-participant device. The processor can be programmed to send the wireless control signal 220 after a start of the communication event. The wireless control signal 220 can be sent using any number of communication signaling schemes including Bluetooth signaling, signaling using an IEEE 802.11 standard, or any other two-way communication signaling for example using transceiver 205 for participant device 204 or transceiver 207 for participant device 206 respectively.

The processor can be further programmed to detect the communication event by detecting an instant messaging session, a telephone conference, a video conference, an audio-visual conference, or a calendared event on an electronic calendar. The electronic calendar can be on one of the communication devices (204 or 206) or can optionally reside in the server 202. The processor can be further programmed to send the wireless control signal by causing any remaining participant devices among the participant devices to send a wireless control signal to any non-participant devices detected by the remaining participant devices. For example, if participant device or communication device 204 detects the non-participant device 208 within the vicinity of device 204 and there is a conference call or other communication event requiring a quiet mode, the system 200 can be programmed to cause any other non-participant devices (210 and 212) to receive a control signal 220 from other participant devices (206).

Such embodiments can address personal communication preference modes based upon a user's current interaction mode and context. If the user is currently in a meeting or a work setting interacting with several others, then inaudible alerts and communication mechanisms for all other users having interaction with non-participant devices can be activated or deactivated as needed by the user or automatically via a broadcast mechanism the user can activate themselves, or a sensor can automatically determine the context/setting and user's current interaction modes such as a teleconference or calendared meeting and automatically deactivate or activate all audible user feedback mechanisms as desired.

Embodiments of the present invention can be incorporated in any wireless or wireline communication device, such as a cellular telephone, two-way radio, personal digital assistant (PDA), personal computer (PC), laptop computer, home entertainment equipment, and the like and also within any software application (NETMEETING/WEBEX, internet conferencing, digital audio/video playback) that helps the user communicate directly or indirectly with other users on wireless or wireline communication devices. For direct communications (also known as point-to-point communications), the participating wireless communication devices can tune their receivers and transmitters to the same channel or channels (e.g., one of a plurality of radio frequency (RF) carriers of the wireless communication system) and communicate over that channel(s).

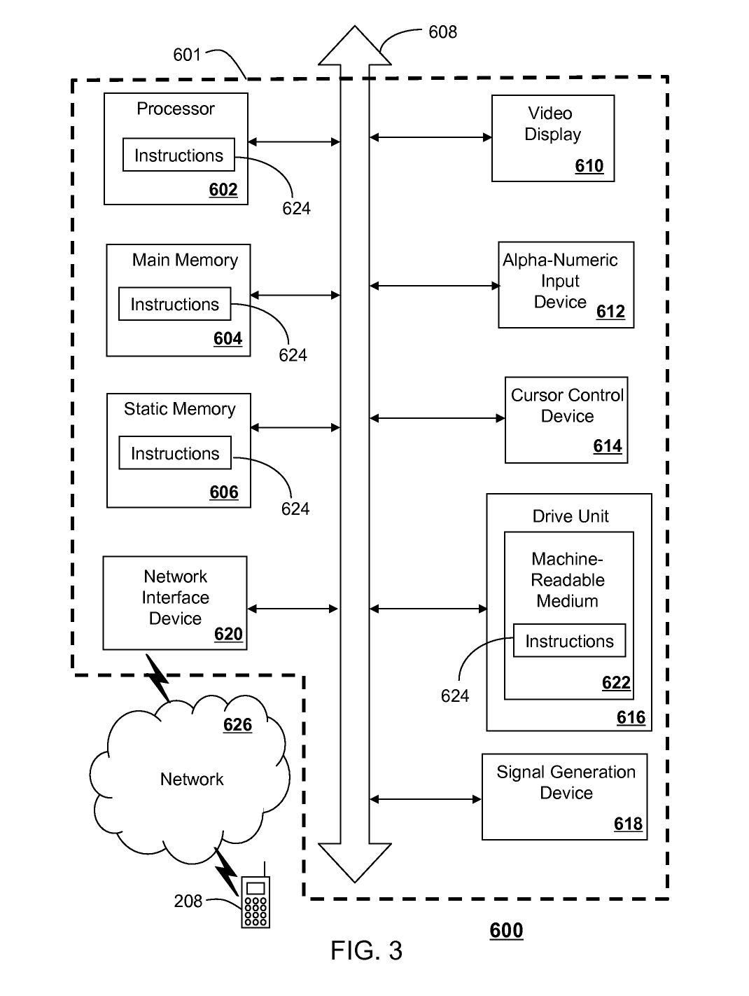

FIG. 3 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 601 and a sending device 208 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 can include a controller or processor 602 (e.g., a central processing unit (CPU), a graphics processing unit (GPU, or both), a main memory 604 and a static memory 606, which communicate with each other via a bus 608. The computer system 600 may further include a presentation device such as a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control that can also serve as a presentation device) and a network interface device 620. Of course, in the embodiments disclosed, many of these items are optional.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of controlling audible alerts, comprising the steps of:
detecting a communication event among participant devices;
detecting a non-participant device within a predetermined range of a participant device; and
sending a wireless control signal by at least one among the participant devices to the non-participant device to control audible alert functions of the non-participant device.

2. The method of claim 1, wherein the method further comprises the step of muting audible alerts on the non-participant device in response to a receipt of the wireless control signal.

3. The method of claim 1, wherein the method further comprises the step of sending the wireless control signal after a start of the communication event.

4. The method of claim 1, wherein the step of sending the wireless control signal comprises sending the wireless control signal using Bluetooth signaling, signaling using an IEEE 802.11 standard, or any other short range two-way communication signaling.

5. The method of claim 1, wherein the step of detecting the communication event comprises the detection of an instant messaging session.

6. The method of claim 1, wherein the step of detecting the communication event comprises the detection of an internet conference, a web conference, an online conference, a telephone conference, a video conference or an audio-visual conference.

7. The method of claim 1, wherein the step of detecting the communication event comprises the detection of a calendared event on an electronic calendar or plurality of calendars.

8. The method of claim 1, wherein the step of sending the wireless control signal by the at least one participant devices causes any remaining participant devices among the participant devices to send a wireless control signal to any non-participant devices detected by the remaining participant devices.

9. A system of controlling audible alerts during communication events, comprising:
a communication device in a communication network; and
a processor coupled to the communication device, wherein the processor is programmed to:
detect a communication event among participant devices including the communication device;
detect a non-participant device within a predetermined range of a participant device; and
send a wireless control signal by at least one among the participant devices to the non-participant device to control audible alert functions of the non-participant device.

10. The system of claim 9, wherein the system mutes audible alerts on the non-participant device in response to a receipt of the wireless control signal by the non-participant device.

11. The system of claim 9, wherein the processor is further programmed to send the wireless control signal after a start of the communication event.

12. The system of claim 9, wherein the communication device sends the wireless control signal by using Bluetooth signaling, signaling using an IEEE 802.11 standard, or any other short range two-way communication signaling.

13. The system of claim 9, wherein the processor is further programmed to detect the communication event by detecting an instant messaging session.

14. The system of claim 9, wherein detecting the communication event comprises the detection of a telephone conference, video conference or audio-visual conference.

15. The system of claim 9, wherein detecting the communication event comprises the detection of a calendared event on an electronic calendar.

16. The system of claim 9, wherein the processor is further programmed to send the wireless control signal by causing any remaining participant devices among the participant devices to send a wireless control signal to any non-participant devices detected by the remaining participant devices.

17. The system of claim 9, wherein the communication device comprises a desktop computer, a computer terminal, a laptop computer, a cellular phone, a smart phone, a personal digital assistant, or a two-way wireless communication device.

18. A portable communication device serving as a client device in a communication network, comprising:
a transceiver; and
a processor coupled to the transceiver, wherein the processor is programmed to:
detect a communication event among participant devices including the portable communication device;
detect a non-participant device within a predetermined range of the portable communication device serving as a participant device; and
send a wireless control signal by at least one among the participant devices to the non-participant device to control audible alert functions of the non-participant device.

19. The portable communication device of claim 18, wherein the processor is further programmed to send the wireless control signal after a start of the communication event.

20. The portable communication device of claim 18, wherein the processor is further programmed to detect the communication event by detecting an instant messaging session, a telephone conference, a video conference, an audio-visual conference, an internet conference, a web conference, a virtual conference, or a calendared event on an electronic calendar.
